(19) United States
(12) Patent Application Publication
(10) Pub. No.: US 2001/0047515 A1
(43) Pub. Date: Nov. 29, 2001

(54) System and method for accessing authorized recordings

(75) Inventor: Scott P. Schreer, Westwood, NJ (US)

Correspondence Address: SHAHAN ISLAM, ESQ., ROSENMAN & COLIN LLP, 575 Madison Avenue, New York, NY, 10022-2585, US

(73) Assignee: Freeplay Music, Inc., New York, NY (US)

(21) Appl. No.: 09/736,874

(22) Filed: Dec. 14, 2000

Related U.S. Application Data
(60) Provisional application No. 60/207,390, filed on May 26, 2000.

(51) Int. Cl. H04N 7/16; H04H 9/00

(52) U.S. Cl. 725/20

(57) ABSTRACT

A method for embedding a digital identification code in a digital recording, and tracking and cataloging the encoded digital recording. The digital signal and the code are received during broadcasts and transmissions. The receiving means has a monitoring means able to recognize and read the embedded code. The monitoring means then records several data, such as time, dates and duration and origin of the broadcasts or transmission. Such data can be retrieved in an easy to read form, thus enabling the end-user to identify the broadcast and transmitted works together with the parameters required to produce accurate royalty reports.

### RELATED APPLICATIONS

This is a non-provisional counterpart to U.S. Provisional Application Serial No. 60/207,390, filed on May 26, 2000.

### FIELD OF THE INVENTION

The present invention relates generally to a music library production business; and, more particularly, to a system and method for accessing authorized recordings in which recordings are provided to major market end-user organizations under the terms of a no-charge license agreement and derives its revenues from performance fee generated when the recordings are broadcast in order to protect the recordings from being illegally copied.

### BACKGROUND OF THE INVENTION

The music licensing industry was created to ensure that songwriters, composers, lyricists and music publishers receive royalties to which they are lawfully entitled when their copyrighted musical creations are publicly performed. In broad terms, licensed music is categorized according to how, where and when the music is used, and how it is performed. License categories include: live concert music, album-oriented music, production music (used in radio and television broadcasts, etc.), feature work music (television broadcasts), background and foreground music (used in public places such as arenas, stadiums, hotels, shopping malls and restaurants), etc.

Television production companies, major broadcasters and cable networks use music to score the programs they broadcast to make their content more dramatic, interesting and entertaining. Although original music can add tremendously to their programs, quite often, time and financial constraints prohibit its use. In order to satisfy this need, a large and growing collection of musical compilations have been created which offer these organizations a variety of musical styles, sound effects and formats that satisfy virtually every production requirement. These compilations or “music libraries” fall into a category of the music licensing industry known as production music. Although precise breakout figures are not publicly available due to category crossovers and limited financial reporting, it is estimated that royalties for the production music segment are at least 15% of the music licensing industry's total annual distributions and possibly much higher.

The production music market segment is highly fragmented. It is composed of dozens of producers offering, perhaps, hundreds of different music libraries. The segment is dominated by a handful (approximately twenty-five) of large, well-capitalized companies, ten of which can be considered premiere. The rest of the library producers in the segment are small “mom and pop” operations; many run as side businesses by performing musicians, with small libraries, usually of mediocre quality, that do not generate significant revenues and performance royalties.

Currently, music library producers are mainly dependent upon the “front-end” creative synchronization and user use fees paid by end-user organizations for the bulk (approximately 80-85%) of their revenues. The rest of their revenues come from the “back-end” performance royalty fees they receive from the performance rights organizations. Due to the inexactitude of passive recognition systems and suspected non-compliance of broadcast information reporting by end-user organizations, it is universally agreed that music library composers and publishers do not receive all of the performance fees to which they are entitled. Furthermore, there is a widespread belief in the music library production business that the allocation and distribution of performance fee revenues by the performance rights organizations will not change until technical advances make the detection and reporting of proof of performance information more accurate, timely and comprehensive.

Due to the cost structure imposed upon them by the current music library business model, most broadcast television and cable networks and television production companies limit the number of libraries that they license, or they elect to pay for their music on a per use or needle drop basis.

Therefore, it is required an improved mechanism which imposes a substantial administrative responsibility upon the above companies to maintain accurate records concerning the music libraries the companies have licensed, and, in addition to the financial impact and administrative burden, exposes the end-user organizations to potentially significant legal liabilities if they use music that has not been licensed.

### SUMMARY OF THE INVENTION

It is therefore an object of the invention to provide a system and method for accessing authorized recordings in which composers and publishers receive all or substantially all of the performance fees to which they were entitled.

A further object of the invention is to create a music catalog record or cue sheet that is acceptable to music publishing companies such as Broadcast Music Inc. (BMI), SESAC, Inc. (SESAC) and American Society of Composers, Authors and Publishers (ASCAP), and other performance rights organizations.

Another object of the system and method is to reduce the administrative responsibility on television and cable networks and television production companies to maintain accurate records concerning the music they have licensed and decrease end-user organization liabilities if it uses music that is not licensed.

Another objective of the invention there is to create and drive new industry paradigms regarding:

i) incentives for end-user organizations to use music in their broadcast productions; and

ii) how music publishers and composers will be paid for the use of the copyrighted material contained in their libraries.

These and other objectives of the invention, which shall become hereinafter apparent, are achieved by the present system and method for accessing authorized recordings. The system and method provides the high quality, comprehensive music which the industry needs to run its businesses and minimize the administrative headaches previously associated with performance reporting. Importantly, it eliminates traditional mechanical, synchronization and master recording fees, while at the same time, promotes building the user's market share. These goals are achieved while attaining extremely high levels of accuracy in collecting royalty payments. The System and Method herein provides its music to major market end-user organizations under the terms of a no-charge license agreement and derive its revenues solely from performance fees generated when they broadcast music.

### BRIEF DESCRIPTION OF THE DRAWINGS

The above and other objects and features of the present invention will become apparent from the following description of preferred embodiments given in conjunction with the accompanying drawings, in which:

FIG. 1 represents a music catalog record of various musical themes broadcast during a televised tennis match.

FIG. 2 represents a single sample record of a work monitored from a coventional radio broadcast. The top panel represents data imported from a musical work library database. The bottom panel represents the data derived from the embedded identification code.

FIG. 3 is a summary of the object/string breakdown as is relates to the types of information within the music monitoring and identification code.

FIG. 4 is an example of a source detail record.

FIG. 5 is a flow-chart illustrating the steps of the method comprising the invention.

### DETAILED DESCRIPTION OF THE PREFERRED EMBODIMENTS

The System and Method will be described herein as follows.

The first step of the System and Method is to encode audio using “watermark” or similar technology which embeds a unique identification number into the audio signal. This is done by either importing the music content from a digital file or converting the audio through an analog to digital (A/D) converter into one's computer.

The digital audio file is then opened in the encoding software and assigned a unique identification code. Once the encoding process is executed, a new file is created with the unique identification number embedded in the audio signal.

The audio file is then copied or played back and recorded on a CD, cassette, videotape, etc. When the encoded audio is broadcast and received by a monitoring station, the unique identification is recognized and recorded along with the date, time it was detected, along with the duration it played. The detections are then compiled (as specified by user) into a “batch file.”

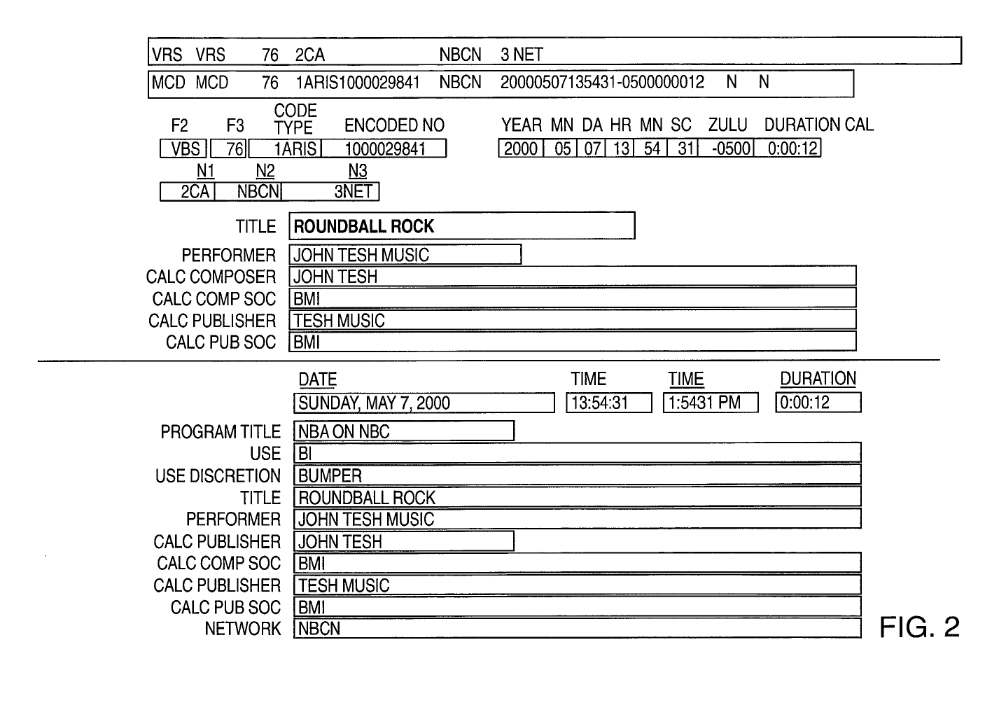

The next step is the importing of the batch files into a database that catalogs the transmission and performance data. The batch files were created by a software monitoring system that detects a unique identification code embedded in the audio signal of a composition, as well as records the date, the time, the duration, and network information. The top of FIG. 2 is a printout of the raw data that has been imported into the music catalog database. Here, it is very easily seen how a compound object is broken out into year, date, month, duration, etc.

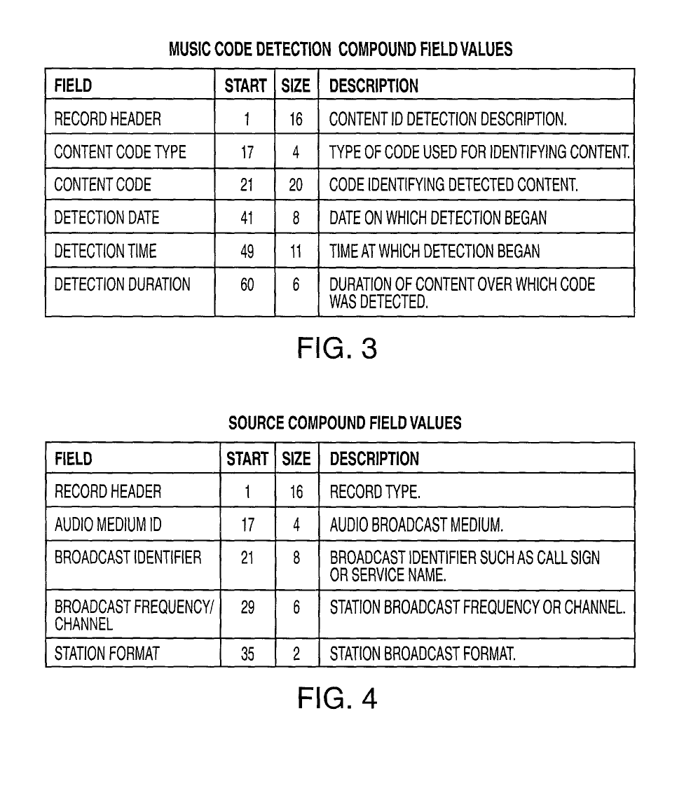

The information is then decoded after importing the records from the monitoring system into the The MCD (music code detection) object/string is broken down as follows. As seen in FIG. 3 which is an example of a table of technology data interchange file format specification, the record header starts at 1 and is 16 characters. The next bit of information is the content code type which starts at character 17 and is four characters long. There is also the content code which starts at character 21 and is 20 characters long. A detection date starts at character 41 and is 8 characters long. The detection time starts at character 49 and is 11 characters long. The detection duration is started at character 60 and is 6 characters long. The duration measurement method starts at character 66 and is 3 characters long. The overlap starts at character 69 and is one character long.

The Source Detail Record object/string is broken down as follows. The record header (see FIG. 4) starts at character 1 and is 16 characters long. The audio medium ID starts at character 17 and is 4 characters long. The broadcaster identifier starts at character 21 and is 8 characters long. The broadcast frequency channel starts at character 29 and is 6 characters long. The station format starts at character 35 and is 2 characters long.

The unique identification number from monitoring station is then taken and matched up with the song title in the “music library database” that has that same identification code.

When those two unique identification codes match up, the song title information from the music library is then imported into a music catalog. As seen in earlier FIG. 2, from the title “Roundball Rock” down, is the information that was imported from the music library such as the title, performer, composer, composer's society, publisher, publisher's society.

To finalize the music catalog, if the program information is not provided by a monitoring device, one would select or input manually the program title, use and usage description from a pull down menu and/or look-up table for each music detection.

Other optional aspects of the system may include “buttons” which open related databases that contain information such as composer and composer's societies, and composers splits and percentages which can be selected from a pull down menu and automatically imported an object of a music library. Another category may be styles of music such as rock, jazz, etc., the tempo of the piece of music, lead instruments that are used, etc. Key words and descriptions and filters could be used for searches.

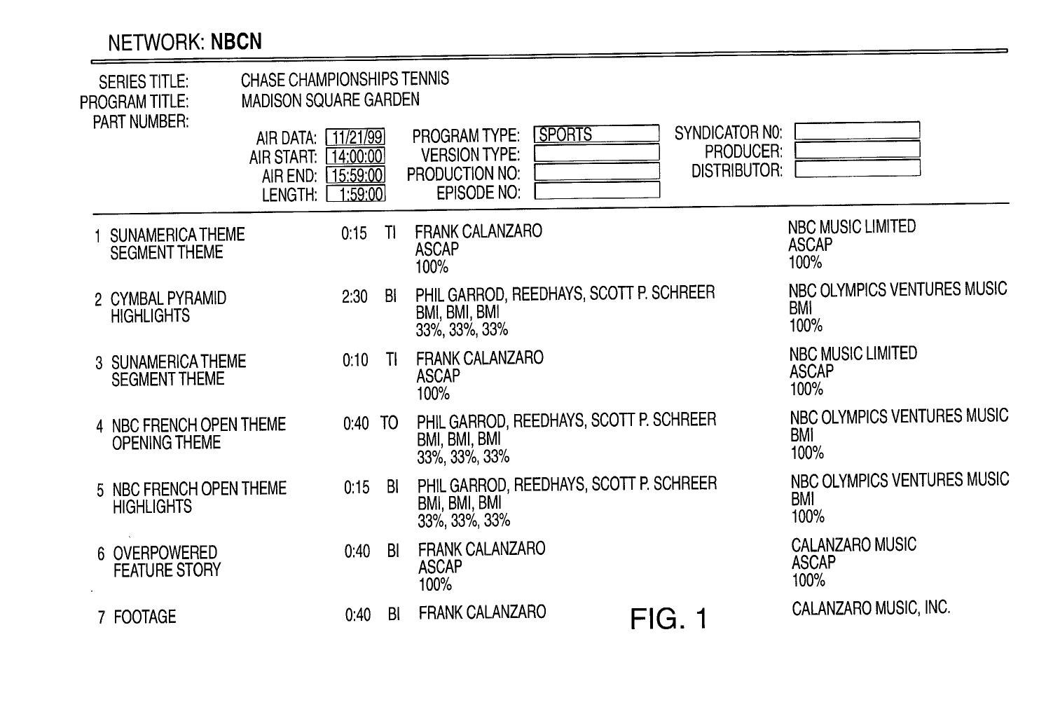

Referring FIG. 1, there is described an example of a music catalog record or cue sheet, which may be printed out. A cue sheet is a report of the usage of the music and includes information such as the publisher, the composer, the publisher's society, the composer's society, the duration of the time that it had aired, the start time, whether it was used as a background or visual performance and a description of that usage.

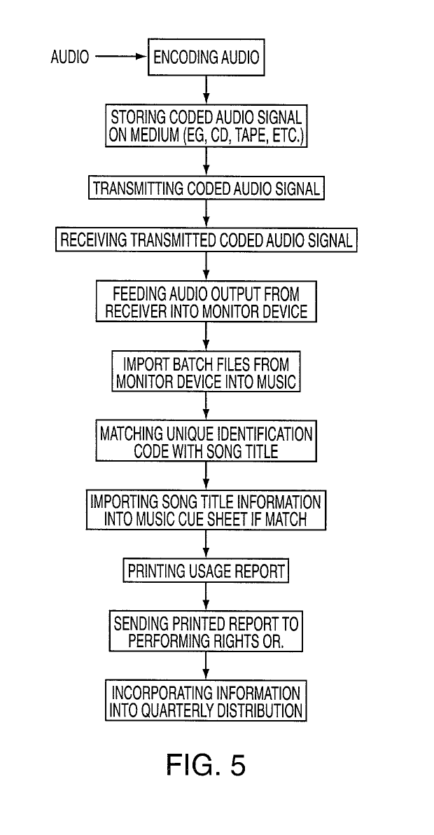

FIG. 5 is a flow chart of the inventive method herein.

Finally, it should be kept in mind that the system and method herein can function not only in connection with music, but with any type of audio and also with video.

The present invention imposes a substantial administrative responsibility upon them to maintain accurate records concerning the music libraries they have licensed, as well as prepare, usually manually, cue sheets that list the title, artist, copyright information, type of usage and time and duration of the music that is played. In addition to the financial impact and administrative burden, the present invention also exposes an end-user organization to potentially significant legal liabilities if it uses music that has not been licensed.

While the preferred and alternate embodiments of the invention have been depicted in detail, modification and adaptations may be made thereto without departing from the spirit and scope of the invention.

What is claimed is:

1. A method for embedding an identification code into a digital recording file, and tracking, and cataloging the encoded recording's broadcasts and transmissions, said method comprising the steps of:
embedding an identification code within a digital recording file;
transferring said encoded file onto a digital signal compatible medium;
transmitting said encoded file as an encoded signal;
receiving said encoded audio signal by a suitable digital signal detecting device;
feeding the received and encoded signal into a monitoring means that recognizes the identification code, and records and stores the code and transmission and broadcast related data as a batch file; and
decoding and importing the batch file into a first database that catalogs performance, transmission and broadcast data, and is capable of printing the data.

2. The method of claim 1, wherein the identification code embedded in the audio signal is a digital watermark.

3. The method of claim 1, wherein the step of embedding the identification code is performed by encoding software.

4. The method of claim 1, wherein the identification code is in the form of a non-audible digital signal that is not rendered inoperable by one or more generations of analog taping and broadcast compressions.

5. The method of claim 1, wherein the transmitting or broadcasting is from a radio or television station, including cable and satellite networks and major internet websites.

6. The method of claim 1, further comprising the steps of:
recording and cataloging by the monitoring means, the identification code, the date that the broadcast was monitored; the time of day that the broadcast was monitored, and the duration of the monitored broadcast.

7. The method of claim 1, further comprising the steps of:
searching a second digital work library database to match the embedded identification code with the title of a digital work and its associated file information, and importing said title and associated information from the second database into the first database.

8. The method of claim 7, further comprising the step of:
using the identification code to match the digital work's title to the collected transmission or broadcast related data and printing a digital work usage report having both the title of the digital work and the transmission and broadcast related data.

9. The method of claim 1, wherein the digital recording file is an audio file.

10. The method of claim 1, wherein the digital recording file is a video or multimedia file.

11. The method of claim 1, wherein the data is printed in the form of cue sheets.
